(19) United States
(12) Patent Application Publication
(10) Pub. No.: US 2005/0083337 A1
(43) Pub. Date: Apr. 21, 2005

(54) Method of storing data-elements

(76) Inventor: Egbert Gerarda Theodorus Jaspers, Eindhoven (NL)

Correspondence Address: Phillips Electronics North America Corporation;Corporate Patent Counsel, PO Box 3001, Briarcliff Manor, NY, 10510, US

(21) Appl. No.: 10/504,662

(22) PCT Filed: Jan. 31, 2003
(86) PCT No.: PCT/IB03/00369

(30) Foreign Application Priority Data
Feb. 21, 2002 (EP) 02075704.3

(51) Int. Cl. G09G 5/39

(52) U.S. Cl. 345/531

(57) ABSTRACT

A method of storing data-elements (1-12) into a memory device (118) comprises: a first grouping step of grouping the data elements (1-12) into a first arrangement of sets (102-108) of data elements (1-12); a first writing step of writing first copies of the respective data elements (1-12) into data-units (120), whereby first copies of those data elements (1,2,3) which belong to a first one (102) of the sets of the first arrangement are written into a first data-unit (120); a second grouping step of grouping the data elements (1-12) into a second arrangement of sets (110-116) of data elements (1-12); and a second writing step of writing second copies of the respective data elements (1-12) into further data-units (122), whereby second copies of those data elements (1,5,9) which belong to a first one (110) of the sets of the second arrangement are written into a second data-unit (122) of the further data-units (122).

The invention relates to a method of storing data-elements by means of applying a memory device having a burst access capability, the method comprising:
a first grouping step of grouping the data elements into a first arrangement of sets of data elements; and
a first writing step of writing first copies of the respective data elements into data-units of the memory device, whereby first copies of those data elements which belong to a first one of the sets of the first arrangement are written into a first data-unit of the data-units.

The invention further relates to a processing apparatus comprising a processor for processing data elements and a memory device for storage of the data elements and which has a burst access capability, with the processing apparatus being arranged to store the data elements by performing a method comprising:
a first grouping step of grouping the data elements into a first arrangement of sets of data elements; and
a first writing step of writing first copies of the respective data elements into data-units of the memory device, whereby first copies of those data elements which belong to a first one of the sets of the first arrangement are written into a first data-unit of the data-units.

As the resolution of video processing applications becomes high, video signal processors have to deal with a large amount of data within a tightly bounded time period. To obtain high memory bandwidth, some memory devices, e.g. SDRAM, use an important feature: the burst access mode. The burst access mode makes it possible to access a number of consecutive data words by giving one read or write command. Because the reading of dynamic memory cells is destructive, the content in a row of cells in the memory bank is copied into a row of static memory cells, the page registers. Subsequently, access to this row of static memory cells is provided. Similarly, when another row has to be accessed, first the content in the row of static memory cells has to be copied back into the original, destructed, dynamic cells. These actions, referred to as row-activations and respectively pre-charges, consume valuable time during which the array of memory cells, i.e. a bank, cannot be accessed. To optimize the utilization of the memory-bus bandwidth, data should only be accessed at the grain size of a data burst, e.g. eight words. These data bursts represent non-overlapping data-units in the memory device which can only be accessed as a whole. Because a request for data may concern only a few bytes, i.e. the data-units are larger than the requested data-blocks, and a request for data can involve more than one data-unit in the memory device, the amount of transfer overhead may be significant. To minimize this overhead a good mapping from logical addresses to physical addresses is important. To illustrate this the following example is provided. A video processing algorithm processes two-dimensional arrays of 8×8 pixels. Such two-dimensional arrays are represented as data-blocks. If the addresses of the various pixels are linearly mapped to physical addresses, accessing such a data-block causes seven row-changes. However if the pixels of such 8×8 data-block are kept in one data-unit of the memory device, accessing such a 8×8 data-block does not induce any row-changes.

From the article “Array Address Translation for SDRAM-based Video Processing Application”, in Visual Communications and Image Processing 2000, Proceedings of SPIE—The International Society for Optical Engineering, Vol. 4067, part two, Year 2000, pages 922-931, is known a memory address translation unit for reducing the number of memory cycles in multi-dimensional video processing applications. In this article an algorithm is described that searches for a suitable window size considering the memory access patterns and memory parameters. A logical array, e.g. a video frame, is partitioned into a set of rectangles called windows. The window size determines how pixels from e.g. a video frame are divided into a number of groups of related pixels. In other words, a video frame is split into a number of regions, wherein the spatial dimensions of such a region correspond to the dimensions of a window. All pixels from such a region belong to one group of related pixels. Each group of related pixels is stored in a row of the memory device. The length of a window corresponds with the number of pixels in horizontal direction. The height of a window corresponds with the number of pixels in vertical direction. Address translation means determination of a physical address for a logical address. To store a data element, e.g. a pixel, into a memory device, a physical address of a data-cell, being a part of a data-unit, has to be calculated for the logical address of the data element. Each pixel has a logical address. This address might be the set of co-ordinates of the pixel within the video frame. If it is required that a group of related pixels has to be stored in one data-unit, then this determines the calculation of the physical addresses related to the pixels to be stored. The pixels from a group of related pixels should be mapped to consecutive physical addresses. In the article a mapping of video data into memory is proposed that is based on analyzing the application software.

The consequence of estimating a window size which is not optimal, is that it results in a mapping of logical to physical addresses that is not optimal. The effect is that a group of related pixels is not stored in one data-unit but spread over several data-units. One data-block request, to access such a group of related pixels has a significant data transfer overhead. The memory device is invoked several times, in stead of performing one burst access. Hence the way data elements are stored is of great importance.

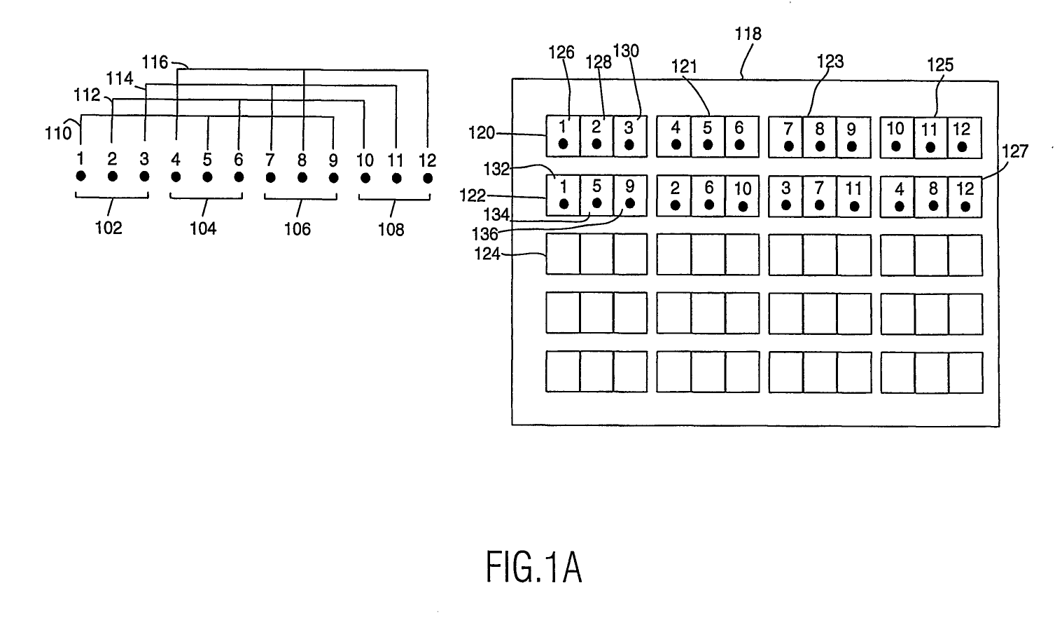

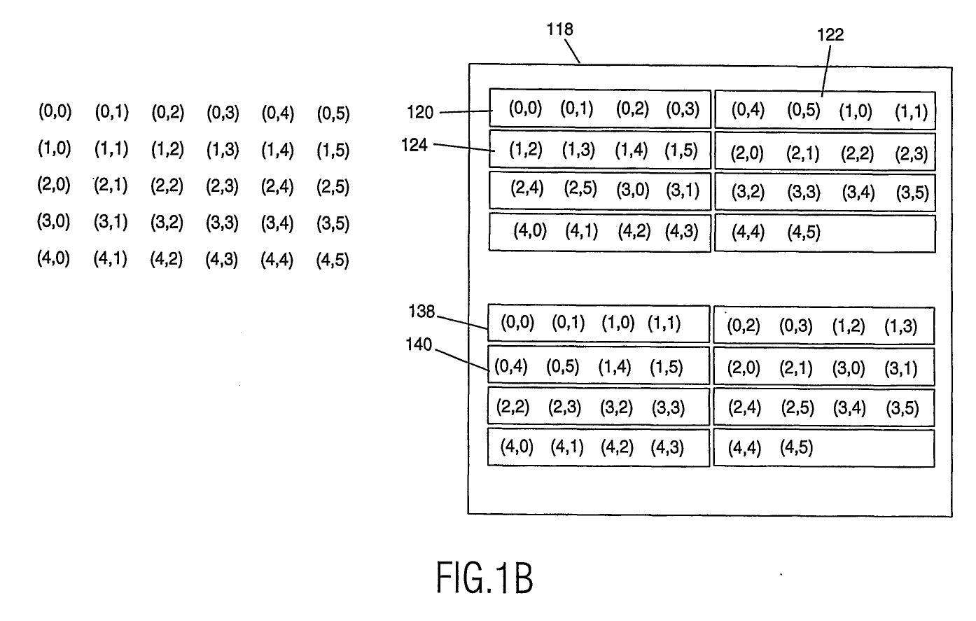

It is an object of the invention to provide a method of the kind described in the opening paragraph with a reduced data transfer overhead. This object is achieved in that the method further comprises:
a second grouping step of grouping the data elements into a second arrangement of sets of data elements; and
a second writing step of writing second copies of the respective data elements into further data-units of the memory device, whereby second copies of those data elements which belong to a first one of the sets of the second arrangement are written into a second data-unit of the further data-units.
   An important aspect of the invention is that multiple copies of the data elements are stored. This enables efficient reading of the copies of the data elements. The advantage of the method according to the invention is that a reduction of bandwidth usage between a processor for processing data elements and the memory device for storage of the data elements is achieved. Although there is additional bandwidth usage of the data bus between the processor and the memory device for writing, the overall bandwidth usage of the data bus is reduced, because the data elements can be accessed for reading with substantially less data transfer overhead. It is advantageous that the first grouping step and the second grouping step are based on subsequent reading of the first copies and the second copies, respectively. This will be explained by means of an example. See also FIG. 1A.

Suppose there are 12 data elements [1-12] which have to be written to a memory device which comprises data-units which can each store 3 data elements. First this data is written sequentially in 4 bursts: [1,2,3], [4,5,6], [7,8,9] and [10,11,12]. This writing does not cause any overhead. Later on the data-elements are required again for further processing and hence they have to be read. Assume that this further processing is performed in a kind of sub-sampled way: one out of four data elements is taken. Hence, first the data elements {1,5,9} are processed. This means that the data-blocks comprising the following triples of data-elements have to be accessed: [1,2,3], [4,5,6] and [7,8,9] resulting in an overhead of 3*2=6 data-elements. Later on, other data-elements are processed correspondingly, e.g. the triple{2,6,10}. This means that the data-blocks comprising the following triples of data-elements have to be accessed: [1,2,3], [4,5,6] and [10,11,12] resulting in an overhead of 3*2=6 data-elements. After all data-elements have been processed in this sub-sampled way resulting in an overhead of 4*6=24, the data-elements are processed in a second way, now in a sequential order, resulting in no overhead. The overall overhead is 24 data-elements.

Alternatively, the data-elements are stored making use of the a-priori knowledge that the data-elements will be needed first in a sub-sampled way and subsequently in a sequential order. Use is made of the invention and the data is written twice resulting in a write overhead of 12 data-elements. The following triples of data elements are stored in the memory device: [1,2,3], [4,5,6], [7,8,9], [10,11,12] and [1,5,9], [2,6,10], [3,7,11], [4,8,12]. However reading the data-elements will not result in any overhead. The overall overhead is less than in the previous case, i.e. 12 versus 24.

In an embodiment of the method according to the invention the memory device is a synchronous dynamic random access memory. The method is useful in the cases that use is made of a memory device having the feature of burst access mode. The burst access mode makes it possible to access a number of consecutive data words by giving one read or write command. An example of such memory device is a synchronous dynamic random access memory (SDRAM) device. Also for accessing more sophisticated memory devices like double data rate synchronous DRAM (DDR SDRAM) or Direct Rambus DRAM the method is beneficial.

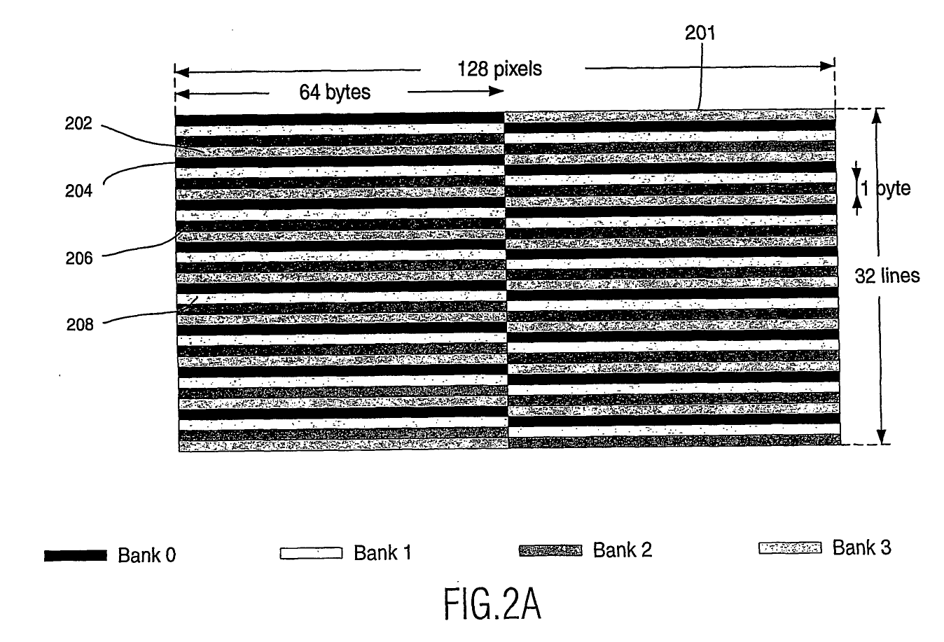

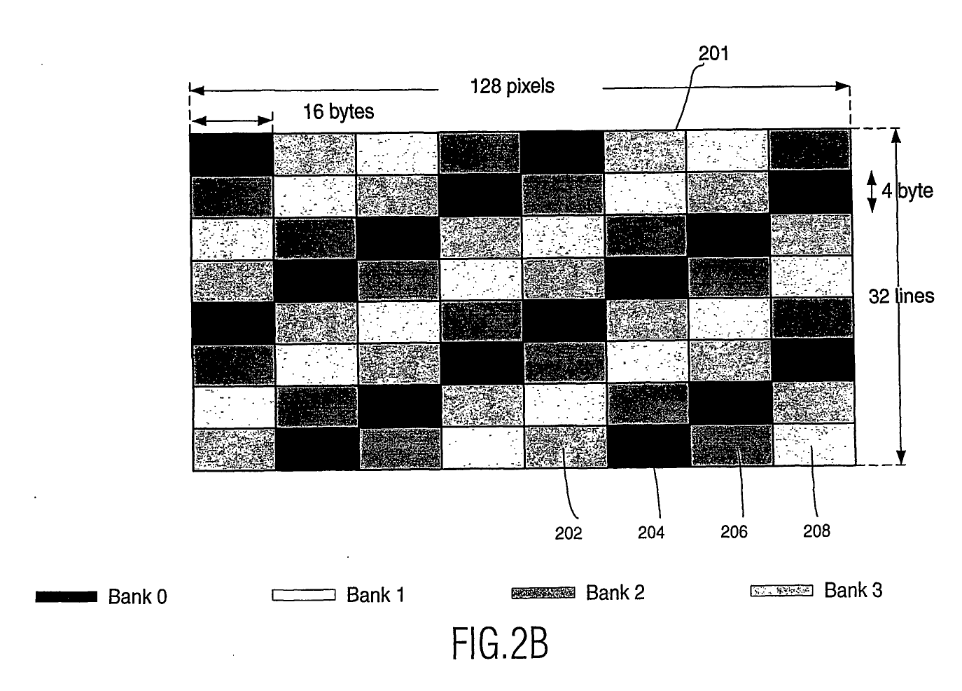

In an embodiment of the method according to the invention, the first one of the sets of the first arrangement corresponds to a data-block of data elements. It is advantageous to apply the method in the case that data-elements correspond to a matrix of elements which can be logically divided in data-blocks. This will be explained by means of an example. See also FIG. 2A and FIG. 2B. Suppose there is a two-dimensional matrix of data elements. Multiple copies of these data elements are stored in a memory device: once corresponding to data-blocks with dimension 64*1 and once corresponding to data-blocks with dimension 16*4. For writing these copies a overhead was required which is equal to the size of the data of the two-dimensional matrix. However read access of a data-block of 16*4 or of a data-block of 64*1 can be without overhead. In that case it is assumed that the overlap between required and stored data is 100%. If only copies where stored corresponding to data-blocks of 64*1, then a read access of a data-block of 16*4 would have resulted in an overhead of 4*(64−16). Again under the assumption that the overlap is 100%. Otherwise the overhead could have been even larger.

In an embodiment of the method according to the invention the first grouping step is based on dimensions of the data-block of data elements. In the article Array Address Translation for SDRAM-based Video Processing Application, in Visual Communications and Image Processing 2000, Proceedings of SPIE—The International Society for Optical Engineering, Vol. 4067, part two, Year 2000, pages 922-931, is described how an optimal mapping between logical and physical addresses can be determined. For the calculation of this mapping several parameters are relevant. It is advantageous to take into account the expected read requests of data-blocks. That means that a priory known knowledge about which data-elements will be needed simultaneously is used to determine the mapping. Hence the dimensions of the data-blocks are parameters to define the mapping. It will be clear that the grouping of data-elements corresponds to mapping of logical to physical addresses.

In an embodiment of the method according to the invention the first grouping step is based on a number of read accesses of the first copies of those data elements which belong to the first one of the sets of the first arrangement. The number of times the first copies will be read is a parameter related to determination of the mapping. This is related to the probability of occurrence of data-blocks in the processing steps of a program. A program can have several types of operands corresponding to types of data-blocks. For example in the case of MPEG the set of data-blocks is V={(16×16), (17×16), (16×17), (17×17), (16×8), (18×8), (16×9), (18×9), (17×8), (17×9), (16×4), (18×4), (16×5), (18×5)}. However these types are not all used with the same frequency. The probability of occurrence and thus request for memory access differs per type. For MPEG applications, the reference pictures are written in memory by means of MacroBlocks. Although the amount of write requests is equal, the probability of occurrence is relative to the total amount of request. Hence, the occurrence probability of the write requests highly depends on the amount of data requests for the prediction. The latter, is determined by amongst others, the amount of field and frame predictions, the structure of the Group Of Pictures (GOP), the amount of forward, backward and bi-directional predicted MacroBlocks in a B-picture, etc. It is advantageous if the mapping depends on the probability of occurrence.

In an embodiment of the method according to the invention the data elements correspond to values of respective pixels of an image. Most video processing algorithms are based on multi-dimensional arrays, i.e. data-blocks and nested loops. Applying the method according to the invention is beneficial for video or still-image processing algorithms. In that case an element of a data-block is related to the value of a pixel. The value of a pixel may represent the luminance value, or the value of one of the color components.

In an embodiment of the method according to the invention the first grouping step is based on whether the display mode is: interlaced or progressive. The display mode is a parameter which is relevant to define the mapping. It is advantageously to take it into account to define the grouping.

It is advantageous to design an image processing apparatus according to the invention. The image processing apparatus might support one or more of the following types of image processing:
Video compression, i.e. encoding or decoding, e.g. according to the MPEG standard.
De-interlacing: Interlacing is the common video broadcast procedure for transmitting the odd or even numbered image lines alternately. De-interlacing attempts to restore the full vertical resolution, i.e. make odd and even lines available simultaneously for each image;
Up-conversion: From a series of original input images a larger series of output images is calculated. Output images are temporally located between two original input images; and
Temporal noise reduction. This can also involve spatial processing, resulting in spatial-temporal noise reduction.

Modifications of the processing apparatus and variations thereof may correspond to modifications and variations thereof of the method described. The processing apparatus may comprise additional components, e.g. an interface unit for receiving a signal representing the images, an interface unit for exporting the processed images or a display device for displaying the processed images.

These and other aspects of the method and of the processing apparatus according to the invention will become apparent from and will be elucidated with reference with respect to the implementations and embodiments described hereinafter and with reference to the accompanying drawing, wherein:

FIG. 1A schematically shows the storage of 12 data elements into a memory device;

FIG. 1B schematically shows the storage of 30 pixels into a memory device;

FIG. 2A schematically shows the mapping of 64×1 pixels onto memory device data-units;

FIG. 2B schematically shows the mapping of 16×4 pixels onto memory device data-units;

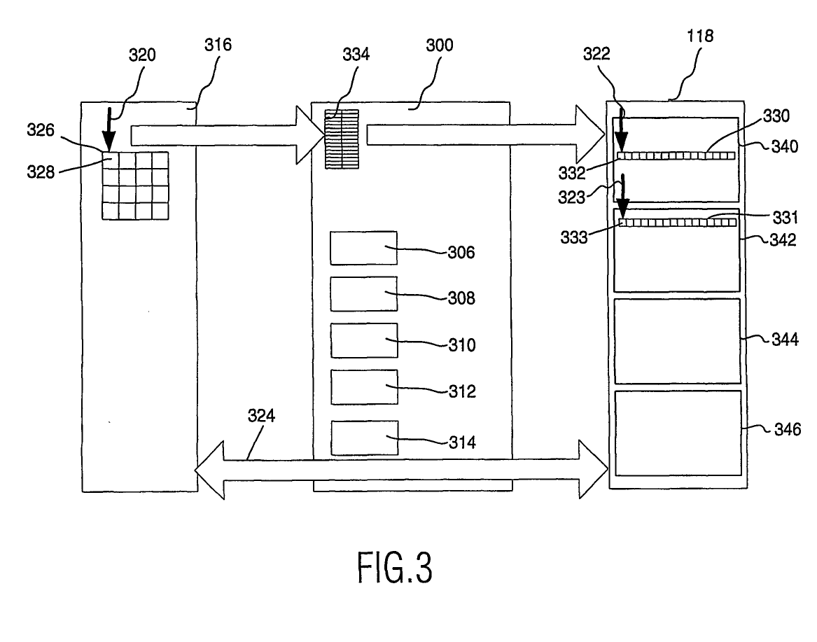

FIG. 3 schematically shows a memory address translation unit and the main components to which the memory address translation unit is connected;

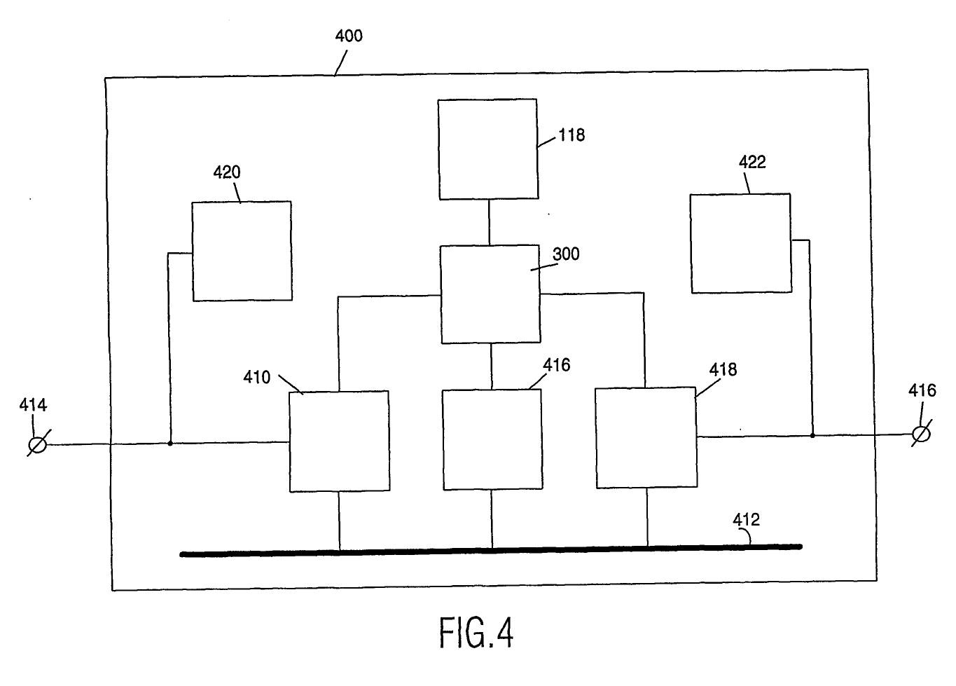

FIG. 4 schematically shows the most important elements of an image processing apparatus according to the invention; and

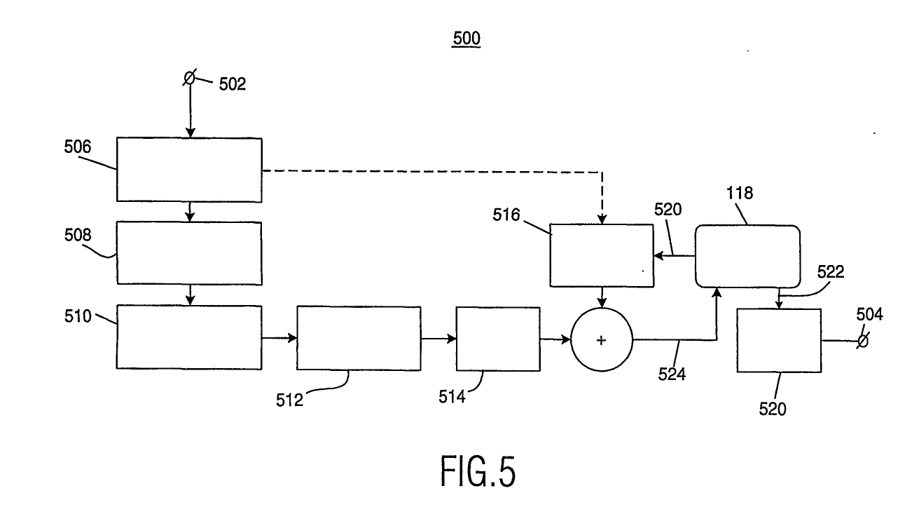

FIG. 5 schematically shows a processing apparatus being designed to perform MPEG decoding.

Corresponding reference numerals have same or like meaning in all of the Figs.

FIG. 1A schematically shows the storage of 12 data elements 1-12 into a memory device 118. The memory device 118 comprises data-units 120-125,127. Each data-unit comprises data-cells 126, 128-136 for the storage of copies of the data-elements 1-12. E.g. data-unit 120 comprises 3 data cells 126,128,130 and data-unit 122 comprises 3 data cells 132-136. In Table 1 the triples of data-elements are listed which are subsequently written into the memory device 118. The identifications of the triples, i.e. sets 102-116 are listed too.

TABLE 1

| Data elements | Set | Data-unit |
|---|---|---|
| [1, 2, 3] | 102 | 120 |
| [4, 5, 6] | 104 | 121 |
| [7, 8, 9] | 106 | 123 |
| [10, 11, 12] | 108 | 125 |
| [1, 5, 9] | 110 | 122 |
| [2, 6, 10] | 112 | . . . |
| [3, 7, 11] | 114 | . . . |
| [4, 8, 12] | 116 | 127 |

FIG. 1B schematically shows the storage of 30 pixels (0,0)-(4,5) into a memory device 118. Two copies of each pixel (0,0)-(4,5) are stored in the memory device 118. First the pixels are grouped into an arrangement of data-blocks of 4×1 pixels. Copies of the pixels are stored according to this arrangement. Then the pixels are grouped into an arrangement of data-blocks of 2×2 pixels and subsequently copies of the pixels are stored according to this arrangement. In Table 2 some of the sets of pixels are listed which are subsequently written. The identifications of the data units 120-124, 138 and 140 are listed too.

TABLE 2

| Pixels | Data-unit |
|---|---|
| (0,0), (0,1), (0,2), (0,3) | 120 |
| (0,4), (0,5), (1,0), (1,1) | 122 |
| (1,2), (1,3), (1,4), (1,5) | 124 |
| . . . | . . . |
| (0,0), (0,1), (1,0), (1,1) | 138 |
| (0,2), (0,3), (1,2), (1,3) | |
| (0,4), (0,5), (1,4), (1,5) | 140 |
| . . . | . . . |

FIG. 2A schematically shows the mapping of 64×1 pixels onto memory device data-units and FIG. 2B schematically shows the mapping of 16×4 pixels onto memory device data-units. It is assumed that one pixel corresponds with one byte. The memory device 201 comprises 64 data-units. Each data-unit can contain 64 bytes. The logical size of the memory device is such that it can keep the pixels from 32 video lines with 128 pixels each. The memory device contains 4 banks. The data-units corresponding to the various banks are indicated with references 202-208. For the mapping of pixels, several options can be recognized. The most straight forward way is to map 64 successive pixels of a video line onto one data-unit as depicted in FIG. 2A. FIG. 2A shows how each consecutive row of 64 pixels is interleaved in the banks in both horizontal and vertical direction. Due to the interleaved mapping, the accesses to the memory nicely address the four banks successively if the pixel data is sequentially read or written. However, when a data-block of 16×16 pixels is requested from the memory device, the amount of data that is transferred is much more. If the data-block is horizontally positioned within one data-unit, 64×16 pixels are transferred. If the data-block overlays two data-units in horizontal direction, the amount of transferred data is 128×16 pixels. When a mapping strategy is chosen as depicted in FIG. 2B, the overhead is less. However, when a data-block of 128×1 is requested, FIG. 2A provides a better mapping strategy.

FIG. 3 schematically shows a memory address translation unit 300 and the main components to which the memory address translation unit 300 is connected. The processor 316 requests for memory accesses. The copies of the data elements are stored in the memory device 118. Each request for memory access by the processor 316 results in a data transfer 324 from the processor 316 to the memory device 118 or vice versa With each write request, the processor 316 provides the logical address 320 of each data element 328 of each data-block 326, that has to be written to this request, to the memory address translation unit 300. The memory address translation unit 300 translates this logical addresses 320 to a physical addresses or physical addresses 322, 323 depending on whether multiple copies should be written. Note that not in all cases multiple copies will be written to the memory device 118. Since, it might be that after writing only one read request will follow. The memory address translation unit 300 provides the physical addresses to the memory device 118. The memory device 118 contains a number of data-units 330, 331. Each data-unit 330, 331 contains a number of data-cells 332, 333. The memory device 118 comprises 4 banks 340-346.

The memory address translation unit 300 comprises the following components:
A memory transfer overhead calculator 306. The memory transfer overhead calculator is designed to calculate the memory transfer overhead for a set of control parameters. A first group of control parameters is related to properties of data-blocks that are stored or retrieved. The properties of a data-block are for example the vertical size and the horizontal size and the probability that a data-block with certain dimensions is accessed. Another aspect is the probability distribution of the physical addresses of each first data element of each data-block. Besides that information, properties of the memory device 118 must be known, e.g. the width of the memory bus and the number of banks 340-346. The organization into memory banks, i.e. a strategy to spread the data-blocks over the various banks 340-346, is an important element for memory bandwidth efficiency. This strategy must be provided to the memory transfer overhead calculator.
A minimum cost establisher 308. The minimum cost establisher provides the memory transfer overhead calculator 306 with various sets of control parameters. The minimum cost establisher is arranged to determine which set of control parameters results in the lowest possible memory transfer overhead. Output from the minimum cost establisher comprises the optimum window size or window sizes. This minimum cost establisher 308 might be designed according to the unit described in the patent application with attorneys docket number PHNL010057.
A mapping generator 310. The mapping generator 310 is arranged to generate the mapping to translate a logical address 320 of a data element 328 of a data-block 326 to a physical address 322, 323 of a data cell 332, 333 of a data-unit 330, 331. To generate this mapping the mapping generator 310 requires information that is calculated by the minimum cost establisher 308. The output from the mapping generator is a look up table 334. This look up table 334 describes the mapping.
An address generator 312. The address generator 312 determines for each instance of a logical address 320 the physical address or addresses 322, 323. It uses the look up table 334.
A memory command generator 314. To access a data-unit 330, 331 in the memory device 118, e.g. SDRAM, first a row-activate command also called Row Address Strobe (RAS) has to be issued for a bank 340-346 to copy the addressed row into the page of that bank. After some delay, a read or write command also called Column Address Strobe (CAS) for the same bank can be issued to access the required data-units in the row. When all required data-units in the row are accessed, the corresponding bank can be pre-charged. The timing of all these commands is critical. The memory command generator, creates these commands for each data access, in the right order and with the right delay in between the commands.

FIG. 4 shows the most important elements of an image processing apparatus 400 according to the invention. The image processing apparatus 400 has a processor 416 for processing data representing images to be compressed, de-compressed, enhanced or filtered. This data may be broadcasted and received via an antenna or cable but may also be data from a storage device like a VCR (Video Cassette Recorder) or DVD (Digital Versatile Disk). The interface unit for importing data 410 has a connector 414. The interface unit for importing data is connected to a bus 412 for data transfer inside the image processing apparatus 400. The data can be sent out via a cable but may also be stored my means of a device like a VCR or CD-Recorder (Compact Disk Recorder). The interface unit for exporting data 418 has a connector 416. The interface unit for exporting data is connected to the bus 412 for data transfer inside the image processing apparatus 400. The data may also be generated by the image processing apparatus 400 by means of an image capture unit 420. The data may also be visualized by the image processing apparatus 400 by means of an image display unit 422. The data can be stored in the memory device 118. Access to data to be stored or retrieved in respectively from the memory device 118 is handled by the memory address translation unit 300. The interface unit for receiving data 410, the interface unit for exporting data 418 and the processor 416 communicate with the memory address translation unit 300 in order to access data.

FIG. 5 schematically shows a processing apparatus 500 being designed to perform MPEG decoding. At the input connector of the processing apparatus 500 a bitstream is provided. The processing apparatus 500 provides a series of images at the output connector 504. The MPEG decoder comprises a variable length decoding unit 506, a run length decoding unit 508 a zigzag scan unit 510, an inverse quantization unit 512, an inverse DCT unit 514 and a motion compensation unit 516. The processing apparatus 500 further comprises a video out unit 520 and a memory device 118. It will be explained how the method of the invention could be applied in this processing apparatus.

For MPEG decoding, both block-based and line-based accesses to the stored data elements is required:
520: memory access is required to read data elements from the memory device 118 for the prediction of MacroBlocks. Both interlaced and progressive data blocks are read. Let Vᵢ be the set of requested interlaced data blocks and Vₚ the set of requested progressive data blocks. These sets consist of the following data blocks which can possibly be requested for prediction. Vᵢ={(16×16), (17×16), (16×17), (17×17), (16×8), (18×8), (16×9), (18×9), (17×8), (17×9), (16×4), (18×4), (16×5), (18×5)} and Vₚ={(16×16), (17×16), (16×17), (17×17), (16×8), (18×8), (16×9), (18×9)}. Because these requested data blocks are motion compensated, they may be located at arbitrary position in the picture and are therefore not necessarily aligned with the data units; i.e. a considerable transfer overhead is generated.
524: reconstructed MacroBlocks are written into the memory device 118. After reconstruction, interlaced or progressive MacroBlocks are written back into the memory. These data blocks have dimensions (16□16) and are aligned on a 16□16 grid, since the MacroBlocks are processed sequentially, scanning the picture from the left to the right and from the top to the bottom.
522: data is read from the memory device 118 for display. To display the reconstructed video, interlaced or progressive data is read line wise from the memory. The reconstructed video data that is written in the memory, is read for display, but is also used as reference data for the prediction. Therefore, the same data in the memory is used for block-based data requests and for line-based requests.

Note that the block-based reading for prediction and the line-based reading for display are contradicting for the optimization of the bus usage. Hence it is proposed to write the reconstructed MacroBlocks twice into the memory device 118, once for prediction 520 and once for display 522. The grouping of data-elements is optimized for each write stream separately to reduce their individual transfer overheads that are caused during reading. Although the double writing of the reconstructed data causes additional data transfer, the overall transfer overhead is reduced significantly, resulting in a net gain of transfer bandwidth. Thus for prediction, the reconstructed MacroBlocks are stored as data blocks with dimensions 16□4. For display the MacroBlocks are stored as data blocks with dimensions 64□1. Most commercially available MPEG encoders use B pictures to achieve a higher performance, i.e. the product of compression ratio and picture quality. For example, the bitstreams might have the following sequence structure: I B P B P B P B I B. For such sequence only half of the data has to be stored as reference data for prediction (only I and P pictures). Consequently, the total request/transfer ratio reduces.

Although this invention proposes to write the decoded data twice into the memory device, the required memory size does necessarily increase proportional. For the conventional decoder, where the decoded data is stored only once, a little bit more than three frame memories are used. In the proposed decoder implementation, four frame memories are needed instead of three although half of the output data is written twice. Thus 50% more data is written whereas only 33% more memory is required. Basically, this is caused by the inefficient use of the three frame memories in the conventional decoder.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps other than those listed in a claim. The word “a”, or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of storing data-elements (1-12) by means of applying a memory device (118) having a burst access capability, the method comprising:
a first grouping step of grouping the data elements (1-12) into a first arrangement of sets (102-108) of data elements (1-12); and
a first writing step of writing first copies of the respective data elements (1-12) into data-units (120) of the memory device (118), whereby first copies of those data elements (1,2,3) which belong to a first one (102) of the sets of the first arrangement are written into a first data-unit (120) of the data-units (120), characterized in that the method further comprises:
a second grouping step of grouping the data elements (1-12) into a second arrangement of sets (110-116) of data elements (1-12); and
a second writing step of writing second copies of the respective data elements (1-12) into further data-units (122) of the memory device (118), whereby second copies of those data elements (1,5,9) which belong to a first one (110) of the sets of the second arrangement are written into a second data-unit (122) of the further data-units (122).

2. A method as claimed in claim 1, characterized in that the first grouping step is based on subsequent reading of the first copies.

3. A method as claimed in claim 1, characterized in that the memory device (118) is a synchronous dynamic random access memory.

4. A method as claimed in claim 1, characterized in that the first one (102) of the sets of the first arrangement corresponds to a data-block (326) of data elements.

5. A method as claimed in claim 4, characterized in that the first grouping step is based on dimensions of the data-block (326) of data elements.

6. A method as claimed in claim 4, characterized in that the first grouping step is based on a number of read accesses of the first copies of those data elements (1,2,3) which belong to the first one (102) of the sets of the first arrangement.

7. A method as claimed in claim 4, characterized in that the data elements correspond to values of respective pixels of an image.

8. A method as claimed in claim 6, characterized in that the first grouping step is based on whether the display mode is: interlaced or progressive.

9. A processing apparatus (300, 400, 500) comprising a processor (316) for processing data elements (1-12) and a memory device (118) for storage of the data elements (1-12) and which has a burst access capability, with the processing apparatus (300, 400, 500) being arranged to store the data elements (1-12) by performing a method comprising:
a first grouping step of grouping the data elements (1-12) into a first arrangement of sets (102-108) of data elements (1-12); and
a first writing step of writing first copies of the respective data elements (1-12) into data-units (120) of the memory device (118), whereby first copies of those data elements (1,2,3) which belong to a first one (102) of the sets of the first arrangement are written into a first data-unit (120) of the data-units (120), characterized in that the method further comprises:
a second grouping step of grouping the data elements (1-12) into a second arrangement of sets (110-116) of data elements (1-12); and
a second writing step of writing second copies of the respective data elements (1-12) into further data-units (122) of the memory device (118), whereby second copies of those data elements (1,5,9) which belong to a first one (110) of the sets of the second arrangement are written into a second data-unit (122) of the further data-units (122).

10. A processing apparatus (300, 400, 500) as claimed in claim 9, characterized in being designed to process images.

11. A processing apparatus (400, 500) as claimed in claim 10, characterized in being designed to perform video compression.

12. A processing apparatus (300, 400) as claimed in claim 10, characterized in being designed to reduce noise in the images.

13. A processing apparatus (300, 400) as claimed in claim 10, characterized in being designed to de-interlace the images.

14. A processing apparatus (300, 400) as claimed in claim 10, characterized in being designed to perform an up-conversion.
